(19) United States
(12) Patent Application Publication
(10) Pub. No.: US 2014/0158620 A1
(43) Pub. Date: Jun. 12, 2014

(54) System And Method For Mechanical And Membrane Oil-Water Separation

(71) Applicant: Water Planet Engineering LLC, Los Angeles, CA (US)

(72) Inventors: Eric M.V. Hoek, Los Angeles, CA (US); Subir Bhattacharjee, Los Angeles, CA (US); Arian Edalat, Los angeles, CA (US); Dian Tanuwidjaja, Los Angeles, CA (US)

(21) Appl. No.: 13/894,311

(22) Filed: May 14, 2013

Related U.S. Application Data
(60) Provisional application No. 61/646,504, filed on May 14, 2012.

(51) Int. Cl. C02F 9/00; C02F 1/00; C02F 1/44; C02F 1/40; C02F 1/38

(52) U.S. Cl. CPC C02F 9/00; C02F 1/40; C02F 1/38; C02F 1/385; C02F 1/44; C02F 1/004
USPC 210/639; 210/195.2; 210/177; 210/178; 210/650; 210/805

(57) ABSTRACT

A system for the separation of the components of an oil, water, and solids mixture, the system comprising a mechanical separation module comprising an oily water output and an input adapted to receive an oil, water, and solids mixture; and a membrane separation module comprising an oily water input and a recirculation output. The oily water output of the mechanical separation module is in flow communication with the oily water input of the membrane separation module, and the recirculation output of the membrane separation module is in flow communication with the input of the mechanical separation module.

### CROSS REFERENCE TO RELATED APPLICATION

This application claims the benefit of U.S. Provisional Patent Application No. 61/646,504, filed on May 14, 2012, the entirety of which is incorporated herein by reference.

### FIELD OF THE INVENTION

The present invention relates generally to oil-water separation, more particularly, to a system and method for mechanical and membrane oil-water separation.

### BACKGROUND OF THE INVENTION

The technical field of oil-water separation applies to the production of oil and gas as well as industrial wastewater treatment sectors. Conventional oil and water separation technologies generally use residence time, temperature, and gravity to separate a three-phase solid-oil-water emulsion. Current oil-water separation techniques require large hold-up volumes and often result in the production of waste streams comprised of highly mixed oil-and-water emulsions.

Accordingly, a need exists for an improved separation system and method that helps solve these and other problems inherent in the prior art.

### SUMMARY OF THE PREFERRED EMBODIMENTS

In accordance with a preferred embodiment of the present invention there is provided a system for the separation of the components of an oil, water, and solids mixture, the system comprising a mechanical separation module comprising an oily water output and an input adapted to receive an oil, water, and solids mixture; and a membrane separation module comprising an oily water input and a recirculation output. The oily water output of the mechanical separation module is in flow communication with the oily water input of the membrane separation module, and the recirculation output of the membrane separation module is in flow communication with the input of the mechanical separation module. Preferably, the mechanical separation module further comprises an oil output. Preferably, the membrane separation module further comprises a water output. Preferably, the mechanical separation module is comprised of at least one of a hydrocyclone block, a bag filter block, or a centrifuge. Preferably, the system further comprises a chemical dosing module. Preferably, the system further comprises a heater module. Preferably, the oil, water, and solids mixture is an emulsion. Preferably, at least one of the modules is skid mounted.

In accordance with another preferred embodiment of the present invention there is provided a method for separating the components of an oil, water, and solids mixture. The method comprises the steps of: removing some of the non-dissolved particulate from the oil, water, and solids mixture by mechanical separation to produce a first output; performing mechanical bulk oil-water separation on the first output to produce a second output; passing the second output through a membrane to produce a third output; and recirculating the third output back into the mechanical bulk oil-water separation step. Preferably, the oil is extracted from the second output following the mechanical bulk-oil water separation step. Preferably, the water is extracted after the second output is passed through the membrane. Preferably, some of the non-dissolved particulate from the oil, water, and solids mixture is removed using at least one of a hydrocyclone block or a bag filter block. Preferably, the bulk oil-water separation is performed using a centrifuge. Preferably, the method further comprises a chemical dosing step prior to the mechanical bulk oil-water separation step. Preferably, the method further comprises a heating step prior to the step of removal of non-dissolved particulate from the oil, water, and solids mixture by mechanical separation. Preferably, the oil, water, and solids mixture is an emulsion. Preferably, the chemical dosing step and heating step control and enhance the rheology, surface chemistry, and particle/droplet size of the emulsion.

In accordance with another preferred embodiment of the present invention there is provided a system for the separation of the components of an oil, water, and solids mixture. The system comprises a mechanical separation module that comprises an oily water output, an oil output, and an input adapted to receive an oil, water, and solids mixture; a membrane separation module that comprises an oily water input, a recirculation output, and a water output; a chemical dosing module; and a heater module. The oily water output of the mechanical separation module is in flow communication with the oily water input of the membrane separation module. The recirculation output of the membrane separation module is in flow communication with the input of the mechanical separation module.

In accordance with another preferred embodiment of the present invention there is provided a method for separating water and oil from a mixture of water, oil, and particulates. The method comprises the steps of: flowing a first mixture of oil, water, and particulates into a vessel to reduce the amount of particulates in the first mixture to thereby form a second mixture of primarily oil and water; flowing the second mixture of oil and water through a separator to reduce the amount of oil in the second mixture thereby forming a third mixture; and flowing the third mixture into the vessel and the separator to further reduce the amount of oil in the third mixture.

In accordance with another preferred embodiment of the present invention there is provided a method for separating water and oil. The method comprises the steps of reducing the amount of oil in an oil-water mixture as a first step to produce a first oil-water mixture; reducing the amount of oil in the first oil-water mixture as a second step to produce a second oil-water mixture; repeating the first step as to the second oil-water mixture such that one or more further oil-water mixtures is produced, and repeating the second step as to the one or more further oil-water mixtures, until at least one of the one or more further oil-water mixtures comprises a significantly reduced oil concentration.

### BRIEF DESCRIPTION OF THE DRAWINGS

FIG. 1 is a flow diagram depicting the modules and components of the present invention;

FIG. 2 is a flow diagram depicting the modules and components of another preferred embodiment of the invention shown in FIG. 1;

FIG. 3 is a flow diagram depicting a portion of the modules and components of the invention shown in FIGS. 1 and 2; and

FIG. 4 is a flow diagram depicting a portion of the modules and components of another preferred embodiment of the invention shown in FIGS. 1 and 2.

### DETAILED DESCRIPTION OF THE PREFERRED EMBODIMENTS

The following description of embodiments of the present invention refers to the accompanying figures. Where appropriate, the same reference numbers in different figures refer to the same or similar elements. The following description and figures are illustrative and are not to be construed as limiting. Numerous specific details are described to provide a thorough understanding of the disclosure. However, in certain instances, well known or conventional details are not described in order to avoid obscuring the description of inventive aspects of the present invention. References to one or an embodiments in the present disclosure can be, but not necessarily are references to the same embodiment; and, such references mean at least one of the embodiments. Unless otherwise stated, like numerals within the figures refer to the same or similar features or aspects of the present invention, as among all figures.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments but not necessarily by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure may be discussed below, or elsewhere in the specification, to provide additional guidance to the practitioner regarding the description of the disclosure. For convenience, certain terms may be highlighted, for example using italics and/or quotation marks; however, the use of highlighting has no influence on the scope and meaning of a term. The scope and meaning of a term is the same, in the same context, whether or not it is highlighted. It will be appreciated that the same thing can be said in more than one way.

Consequently, alternative language and synonyms may be used for any one or more of the terms discussed herein. Nor is any special significance to be placed upon whether or not a term is elaborated or discussed herein. Synonyms for certain terms may be provided. A recital of one or more synonyms does not exclude the use of other synonyms. The use of examples anywhere in this specification, including examples of any terms discussed herein, is illustrative only and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art in the field of the present invention. In the case of conflict, the present document, including definitions, will control.

Described herein is a system and method of recovering both a pipeline ready oil and purified water from industrial oil-water emulsions including the steps of solids removal from an oil-water emulsion, chemical dosing to the oil-water emulsion to assist the demulsification, heating to improve the flow of the emulsion, primary oil removal from the oil-water emulsion via mechanical separation, water removal from the remaining emulsion via membrane separation, recirculating the membrane concentrate to the upfront mechanical separation feed to dilute the system influent emulsion and increasing subsequent system separation performance, and adjusting water draw from membrane separation to control and stabilize system influent oil-water concentration. The invention comprises a modular near zero liquid discharge solid-oil-water separation technology that is skid mounted and compact, is able to recover preferably over 99% of the influent water and oil, includes near zero liquid discharge (waste preferably less than 1%), and is able to operate and perform robustly and consistently with variations and upsets within the influent water quality.

Relative to the state of the art, the invention disclosed herein provides at least the following advantages: Reduces the cost of treated water; improves crude oil recovery; reduces the liquid waste produced by the treatment trains; improves water de-oiling; improves the recoverability of the influent stream for beneficial purposes, product oil or treated water.

By the modular implementation of a solids handling module, followed by two emulsion conditioning modules, followed by mechanical oil-water separation, followed by membrane separation, in conjunction with a recirculation of down stream membrane concentrate, the invention is able to process a solid-oil-water emulsion, minimize liquid waste discharge, and produce an upgraded oil effluent and a high quality polished water effluent and a minimal upfront solid waste stream.

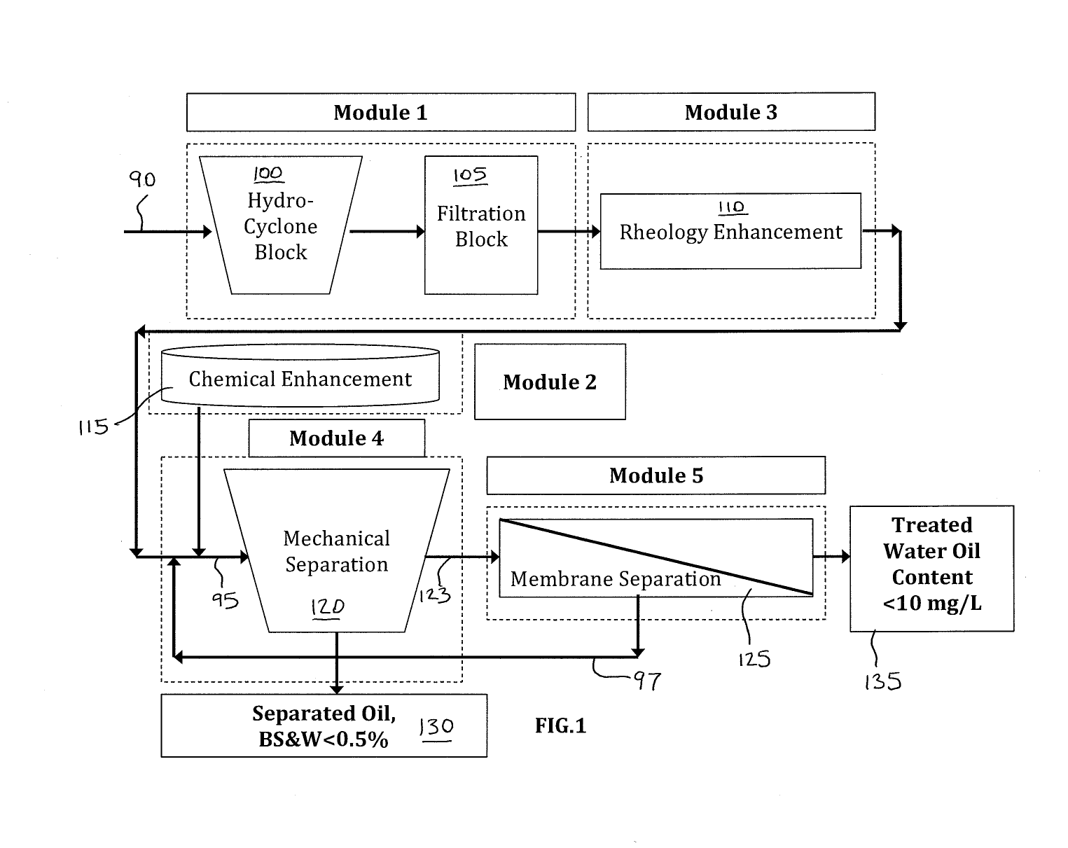

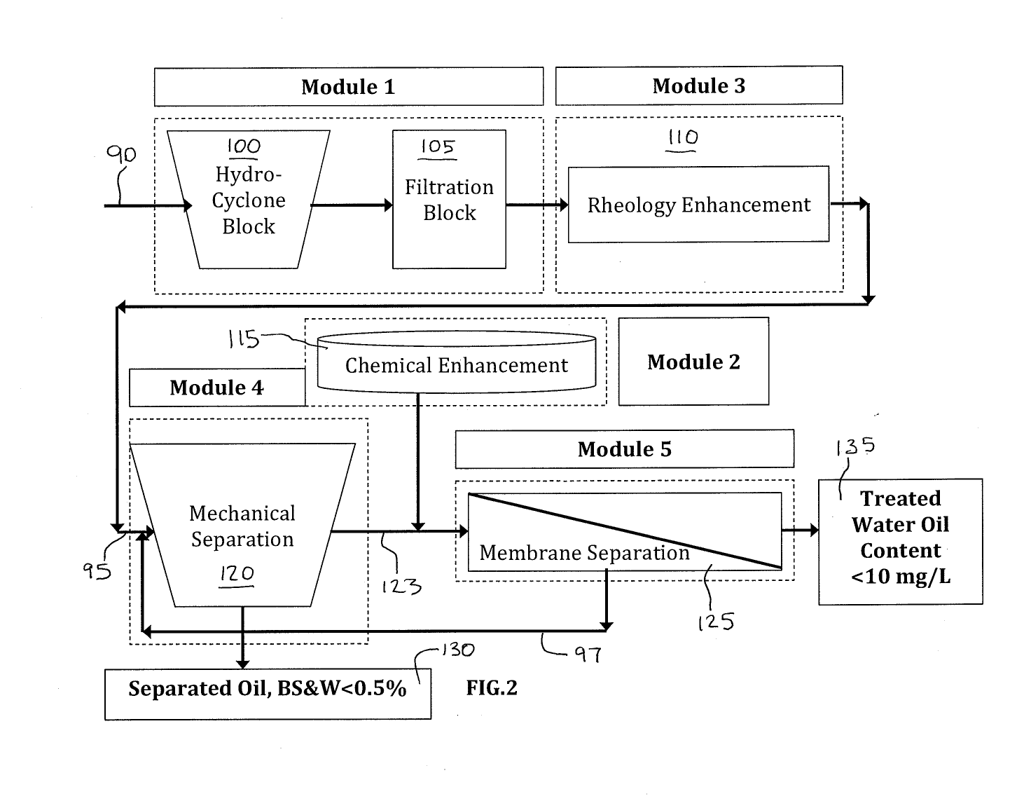

Referring now to FIG. 1, a process flow diagram for the complete modular system is shown. Arrows shown in FIG. 1 (as well as in FIGS. 2 through 4), depict interconnection as between different modules, components, and steps, as well as the direction of material flow through the various modules, components, and steps shown. The oil, water, and solids mixture (or oil and water mixture) enters the system at input 90. The solid separation module or step (Module 1) removes non-dissolved particulate from the solid-oil-water emulsion, and is comprised of a hydrocyclone block or step 100 and a filtration block or step 105 (which filtration block or step 105 may be comprised of a bag & filter block). The solid separation module or step (Module 1) may be performed mechanically. The solid separation module (Module 1) separates solids down to 10 microns. The emulsion conditioning modules or steps (Modules 2 and 3) control the particle size and rheology of the emulsion through a controlled chemical addition or enhancement component or step 115 (at Module 2), and temperature control/rheology enhancement component or step 110 (such as through heating), shown at Module 3. The controlled chemical addition or enhancement component or step 115 demulsifies the feed emulsion. The temperature control/rheology enhancement component or step 110 improves the flow of highly viscous and dense influents. The temperature control/rheology enhancement component or step 110 provides an additional platform to assist demulsification.

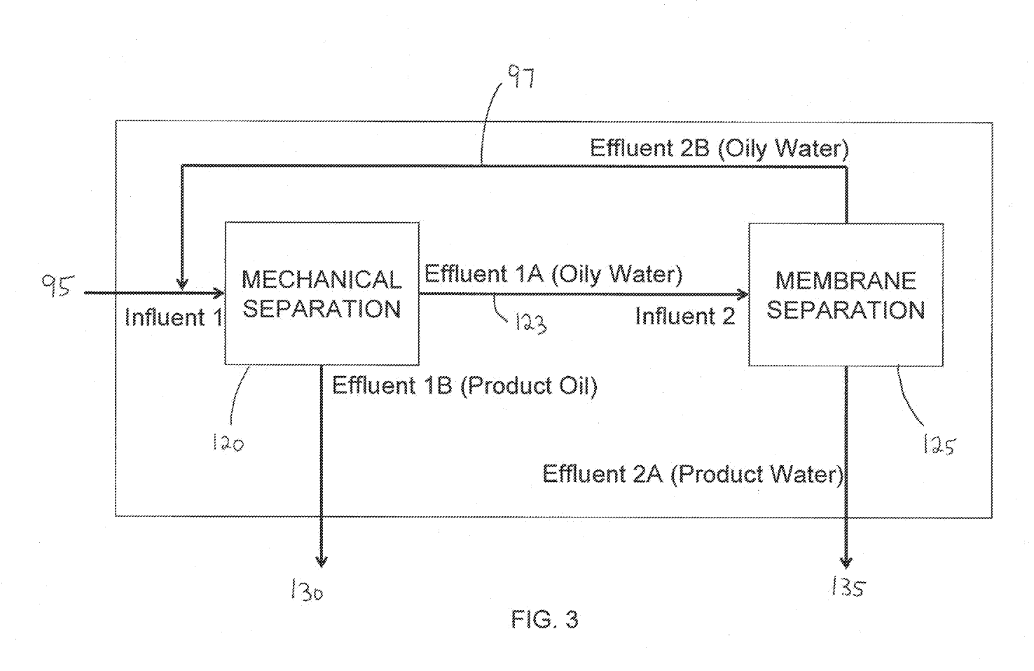

Still referring to FIG. 1 (and concurrently, to FIG. 3), the invention's mechanical separation component or step 120 (Module 4) performs the bulk oil-water separation (Influent 1, shown at input 95). The mechanical separation of mechanical separation component or step 120 may be conducted by (1) flotation such as DAF (dissolved air flotation) or IGF (induced gas flotation) units or similar, (2) gravity such as settling tanks, skim tanks, belt skimmers, or similar, (3) accelerated gravity such as centrifuges, CPI units, or similar, or (4) other mechanical techniques and equipment that could be used to separate an oil-water separation mixture to produce one low oil concentration water stream effluent and one separate recovered oil stream (such as that shown as Effluent 1A at output 123, and Effluent 1B at output 130), as will readily be apparent to those of skill in the art. The recovered oil stream (Effluent 1B at output 130) is removed from the invention's system loop or can also be sent to a secondary oil-upgrading step. The Effluent 1B at output 130 preferably comprises separated oil having a basic sediment and water (“BS&W”) percentage of preferably less than 0.5%, and it significantly reduces the water-oil content, including and preferably (but not limited to) below 300 parts per million (“ppm”).

As shown in FIGS. 1 and 3, the water stream effluent (Effluent 1A at output/input 123) of mechanical separation component or step 120 that is contaminated with low levels of oil is then fed to a membrane filtration system or membrane separation component 125 (Module 5) (Influent 2 at output/input 123). This polishing component or step of mechanical separation component or step 120 further filters the mechanical system's water effluent in a cross flow configuration, which results in one further polished water effluent (Effluent 2A at output 135) and one membrane system concentrate effluent (Effluent 2B at output 97). Effluent 2A at output 135 can produce treated water with an oil content of less than 10 mg per liter. Effluent 2B at output 97 is recirculated back to input 95.

In another preferred embodiment, shown in FIG. 2, the chemical additional or enhancement component or step 115 may be placed in between the mechanical separation component or step 120 and the membrane separation component or step 125.

Beyond the adaptability and efficiency of the five modules, there are distinct advantages in the process flow of the different modules' influents and effluents. Referring now to FIG. 3, because the upfront mechanical oil-water separation component or step 120 (Module 4) at mechanical separation produces a low-level oil concentration effluent water (Effluent 1A at output/input 123) to feed to the membrane system (Influent 2 at output/input 123), the membrane feed can be recovered through filtration to a very high level of water purity. The membrane system's secondary liquid waste stream (Effluent 2B at output 97), e.g., concentrate, is then recirculated back to the feed of the original mechanical separator (Influent 1 at input 95). Due to the mass balance of such an initial mechanical separation followed by secondary membrane system, the concentrate of the membrane stream (Effluent 2B at output 97) will dilute the feed stream (Influent 1 at input 95), which in turns lowers the load placed on the entire system and increases the overall separation capabilities of the system.

Still referring to FIG. 3, additionally, the invention's recirculation loop (Effluent 2B at output 97 to Influent 1 at input 95) enables greater control over the complete system. As the mechanical separation's influent oil-to-water concentration increases due to common variations in raw emulsion of expected industry applications, the system and method of the present invention can manually or dynamically be adjusted to reduce the recovery of the polished water effluent (Effluent 2A at output 135) recovered in the membrane separation, which lowers the oil-to-water concentration of the membrane concentrate (Effluent 2B at output 97), which in turns dilutes the incoming feed (Influent 1 at input 95) further causing and enabling a more consistent influent water quality (Influent 2 of output/input 123). Additionally, because the membrane concentrate stream (Effluent 2B of output 97) is fully recirculated back to the front of the system (Influent 1 at input 95) and mixed with the raw influent (derived upstream from the rheology enhancement component or step 110 of Module 3), the present invention is able to eliminate the need to discharge the membrane concentrate (Effluent 2B of output 97). Therefore, the resulting effluents from the system are an upgraded oil effluent (Effluent 1B of output 130) and a highly polished product water effluent (Effluent 2A of output 135).

The influent oil content at Influent 1 at input 95 can range between 5% and 35% by volume (at the highest range), between 1% and 5% by volume (at a medium or middle range), and less than 1% by volume (at the lowest range). The influent solids content at Influent 1 at input 95 is preferably between 2% and 5% by volume (at the highest range), between 1% and 2% by volume (at a medium or middle range), and less than 0.5% by volume (at the lowest range). The oil effluent BS&W content (using ASTM D4007-11 Method) at output 130 is reduced or significantly reduced, including and preferably (but not limited to) in the range of 0.1% to 0.5% by volume. The water effluent oil and/or grease content (using EPA-1664A Method) at output 135 is reduced or significantly reduced, including and preferably (but not limited to) in the range of 10 ppm to 100 ppm, more preferably in the range of 0 ppm to 10 ppm, and most preferably in the range of 0 ppm to 5 ppm.

The hydrocyclone block 100 of Module 1 can be any desanding hydrocyclone known to those of skill in the art, including, for example (and not by way of limitation), Enerscope Models ESI-0005-150, ESI-0030-150, or equivalents. The bag filter/filtration block 105 of Module 1 can be any model or type known to those of skill in the art, including, for example (and not by way of limitation), Filtersource.com models: Flowline II; Ecoline, EBF-0104-AB10-015N; Maxiline MBF HD, MBF-0302-AB10-030A-UT-11HD; Maxiline VMBF SE, VBMF-0402-AB10-040A-UT-11SE; or equivalents. The tanks used for the chemical addition or enhancement component or step 115 can be any known to those of skill in the art, including, for example (and not by way of limitation), Prominent Dosing Tanks PE. The heaters used for the temperature control/rheology enhancement component or step 110 can be any known to those of skill in the art, including, for example (and not by way of limitation), Process Heating Corp. Model FPH-100 and customized models; Watlow Models WATROD-CFWN754J13S or WATROD-CFWN763J13S; Chromalox Model NWHSS-90-950P-E2; customized models made by Ex-Heat; or equivalents. To the extent a centrifuge is used for mechanical component or step 120 (Module 4), the centrifuge can be any known to those of skill in the art, including, for example (and not by way of limitation), CINC Industries, Models V-05, V-10, V-16, V-20, or equivalents.

The membrane separation component or step 125 contains membranes housed in modules in a variety of form factors. An oleophobic (oil tolerant), hydrophilic membrane with molecular weight of 50 kDaltons or below is used. The membrane material can be made of Polyvinylidene fluoride (PVDF) or PolyacryInitrile (PAN) or equivalent. Such membrane components can be any known to those of skill in the art, including, for example (and not by way of limitation) Sepro's range of PVDF and PAN membranes. Upstream of the membranes, pre-treatment can be incorporated in form of any bag, coalescer, or cartridge filters, and/or a coalescence enhancing gravity based vessel, or equivalents known to those of skill in the art.

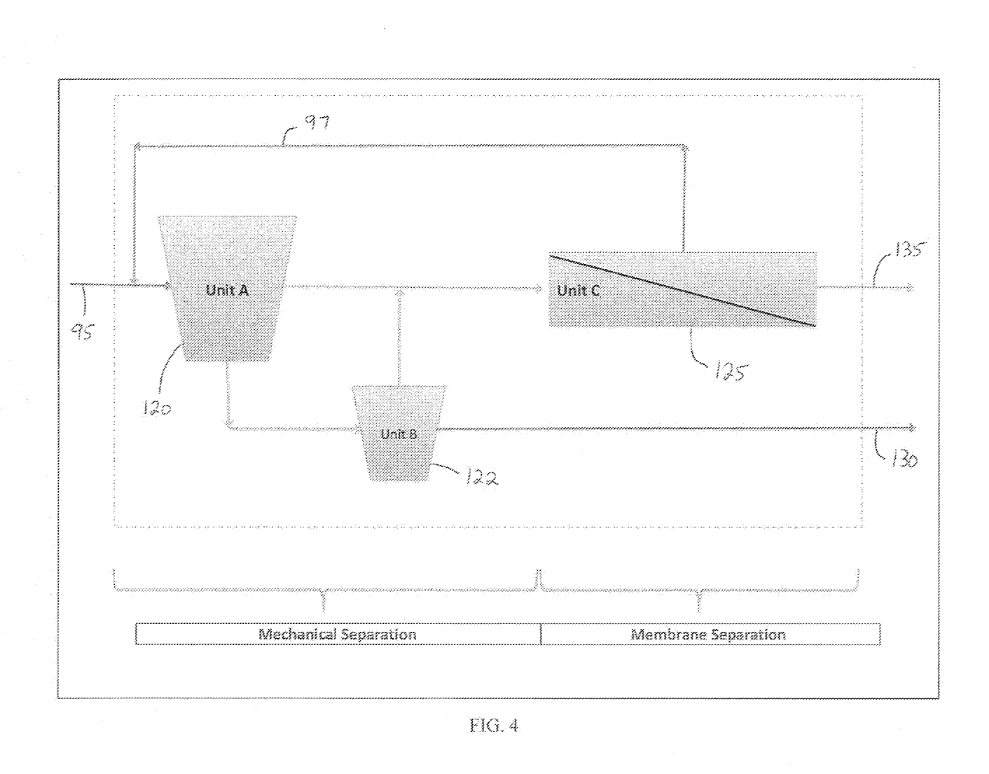

Referring to FIG. 4, another preferred embodiment of the invention is shown, where Unit A is the primary oil/water separator 120 (corresponding to mechanical separation component or step 120 of FIGS. 1-3), Unit B is the oil upgrading module 122, and Unit C is the membrane separation component or step 125 (corresponding to the membrane separation component or step 125 of FIGS. 1-3). As depicted in FIG. 4, the membrane separation component or step may be comprised of pre-treatment followed by membrane separation. The inputs and/or outputs 95, 97, 130, and 135 of FIG. 4 correspond to the same inputs/outputs described above and shown in FIGS. 1 through 3.

Three examples of expected operation of the present invention for a given influent oil and water content are provided below, which demonstrate the distinct and innovative advantages of the recirculation process flow. The following examples utilize influent quality, specified flow rate (Influent 1 at input 95 in FIGS. 1-4) and a series of the unit operating conditions for various invention modules as inputs. The outputs consist of flow rates and oil/water contents of recovered oil and treated water (Effluent 1B at output 130, and Effluent 2A at output 135, of FIGS. 1-4), as well as overall recovery of the system in terms of pipeline transportable oil and treated water quality. In the following examples, influent conditions are the flow rate and oil and water contents. For operations of Units A and B (of FIG. 4), the expected concentration thresholds for oil and water effluents from each unit are shown in the examples. For operations of Unit C (of FIG. 4), the deoiling efficiency of pre-treatment, membrane filtrate recovery rate, and rejection are shown in the examples. Flow rates, and oil and water content of Effluent 1B at output 130 and Effluent 2A at output 135 (of FIGS. 1-4) are shown in the examples.

The influent conditions in the following examples represent high, medium, and low oil containing produced waters, as shown in Table 1.

TABLE 1
Influent Characteristics for Influent Examples “A,” “B,” and “C”:

| Influent | Oil Content (vol. %) | Water Content (%) |
|---|---|---|
| A | 20 | 80 |
| B | 2 | 98 |
| C | 0.1 | 99.9 |

Examples showing expected operation of the present invention for each influent are shown below. The influent flow rate is assumed to be a constant 30 gallons per minute (gpm) for each example. “Unit A,” “Unit B,” and “Unit C” in the tables below correspond to A, Unit B, and Unit C depicted in FIG. 4 and described above.

### Example

### Influent “A”

TABLE A-1
Operational Inputs for Influent “A” Example:

| | Oil Effluent Water | Water Effluent Oil |
|---|---|---|
| | Content (Vol. %) | Content (Vol. %) |
| Unit A | 25 | 0.05 |
| Unit B | 0.5 | 0.5 |
| Unit C | | |
| Membrane Pre-treatment | 60% | |
| efficiency | | |
| Membrane Rejection | 99% | |
| Membrane permeate | 75% | |
| recovery | | |

TABLE A-2
Influent “A” Example: Specifications for Stream 1 (Influent 1
at input 95), Stream 2 (Effluent 2A at output 135),
and Stream 3 (Effluent 1B at output 130):
Flow Rates (GPM)

| | | | Oil/Water |
|---|---|---|---|
| Stream | Oil | Water | concentration |
| 1 | 6.00 | 24.00 | Oil Content: 20 vol. % |
| 2 | 9 × 10⁻⁵ | 23.94 | Oil Content: 4 mg/L |
| 3 | 5.986 | 0.03 | BS&W Content: 0.5 vol. % |

TABLE A-3
Influent “A” Example: Separated oil and
treated water recovery and waste production (showing
invention's ability to minimize waste streams):

| | Flow rate (GPM) | Yield (%) |
|---|---|---|
| Separated Oil Recovery | 5.99 | 99.76 |
| Treated Water Recovery | 23.94 | 99.76 |
| Overall Influent Recovery | 99.76% | |
| Waste | 0.24% | |

### Example

### Influent “B”

TABLE B-1
Operational Inputs for Influent “B” Example:

| | Oil Effluent Water | Water Effluent Oil |
|---|---|---|
| | Content (Vol. %) | Content (Vol. %) |
| Unit A | 75 | 0.02 |
| Unit B | 0.5 | 0.5 |
| Unit C | | |
| Membrane Pre-treatment | 60% | |
| Oil Removal | | |
| Membrane Rejection | 99% | |
| Membrane permeate | 75% | |
| recovery | | |

TABLE B-2
Influent “B” Example: Specifications for Stream 1 (Influent 1
at input 95), Stream 2 (Effluent 2A at output 135),
and Stream 3 (Effluent 1B at output 130):
Flow Rates (GPM)

| | | | Oil/Water |
|---|---|---|---|
| Stream | Oil | Water | concentration |
| 1 | 0.60 | 29.40 | Oil Content: 2 vol. % |
| 2 | 4 × 10⁻⁵ | 29.37 | Oil Content: 1 mg/L |
| 3 | 0.594 | 0.003 | BS&W Content: 0.5 vol. % |

TABLE B-3
Influent “B” Example: Separated oil and
treated water recovery and waste production (showing
invention's ability to minimize waste streams):

| | Flow rate (GPM) | Yield (%) |
|---|---|---|
| Oil | 0.594 | 98.98 |
| Water | 29.37 | 99.89 |
| Overall Influent Recovery | 99.88 vol. % | |
| Waste | 0.12 vol. % | |

### Example

### Influent “C”

TABLE C-1
Operational Inputs for Influent “C” Example:

| | Oil Effluent Water | Water Effluent Oil |
|---|---|---|
| | Content (Vol. %) | Content (Vol. %) |
| Unit A | 95 | 0.02 |
| Unit B | 10 | 0.5 |
| Unit C | | |
| Membrane Pre-treatment | 60% | |
| Oil Removal | | |
| Membrane Rejection | 99% | |
| Membrane permeate | 75% | |
| recovery | | |

TABLE C-2
Influent “C” Example: Specifications for Stream 1 (Influent 1
at input 95), Stream 2 (Effluent 2A at output 135),
and Stream 3 (Effluent 1B at output 130):
Flow Rates (GPM)

| | | | Oil/Water |
|---|---|---|---|
| Stream | Oil | Water | concentration |
| 1 | 0.03 | 29.97 | Oil Content: 0.1 vol. % |
| 5 | 3 × 10⁻⁵ | 29.94 | Oil Content: 1 mg/L |
| 9 | 0.025 | 0.003 | BS&W Content: 10 vol. % |

TABLE C-3
Influent “C” Example: Separated oil and
treated water recovery and waste production (showing
invention's ability to minimize waste streams):

| | Flow rate (GPM) | Yield (%) |
|---|---|---|
| Oil | 0.025 | 83.77 |
| Water | 29.94 | 99.89 |
| Overall Influent Recovery | 99.88% | |
| Waste | 0.12 | |

The particular arrangement of the present invention shown in the figures and described herein is intended to be only exemplary. Various details of the invention may be changed without departing from the scope of the invention. Furthermore, the foregoing description of the preferred embodiment of the invention and best mode for practicing the invention are provided for the purpose of illustration only and not for the purpose of limitation, the invention being defined by the claims.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of, and examples for the disclosure are described above for illustrative purposes, various equivalent modifications are possible within the scope of the disclosure, as those skilled in the relevant art will recognize. Further any specific numbers noted herein are only examples; alternative implementations may employ differing values or ranges.

Any patents and applications and other references that may be noted herein, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure. Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A system for the separation of the components of an oil, water, and solids mixture, the system comprising:
a mechanical separation module comprising an oily water output and an input adapted to receive an oil, water, and solids mixture;
a membrane separation module comprising an oily water input and a recirculation output;
wherein the oily water output of the mechanical separation module is in flow communication with the oily water input of the membrane separation module; and
wherein the recirculation output of the membrane separation module is in flow communication with the input of the mechanical separation module.

2. The system of claim 1, wherein the mechanical separation module further comprises an oil output.

3. The system of claim 2, wherein the membrane separation module further comprises a water output.

4. The system of claim 3, wherein the mechanical separation module is comprised of at least one of a hydrocyclone block, a bag filter block, or a centrifuge.

5. The system of claim 4 further comprising a chemical dosing module.

6. The system of claim 5 further comprising a heater module.

7. The system of claim 6, wherein the oil, water, and solids mixture is an emulsion.

8. The system of claim 7, wherein at least one of the modules of the system is skid mounted.

9. A method for separating the components of an oil, water, and solids mixture, the method comprising the steps of:
removing some of the non-dissolved particulate from the oil, water, and solids mixture by mechanical separation to produce a first output;
performing mechanical bulk oil-water separation on the first output to produce a second output;
passing the second output through a membrane to produce a third output; and
recirculating the third output back into the mechanical bulk oil-water separation step.

10. The method of claim 9, wherein oil is extracted from the second output following the mechanical bulk-oil water separation step.

11. The method of claim 10, wherein water is extracted after the second output is passed through the membrane.

12. The method of claim 11, wherein some of the non-dissolved particulate from the oil, water, and solids mixture is removed using at least one of a hydrocyclone block or a bag filter block.

13. The method of claim 12, wherein the bulk oil-water separation is performed using a centrifuge.

14. The method of claim 13, further comprising a chemical dosing step prior to the mechanical bulk oil-water separation step.

15. The method of claim 14, further comprising a heating step prior to the step of removal of non-dissolved particulate from the oil, water, and solids mixture by mechanical separation.

16. The method of claim 15, wherein the oil, water, and solids mixture is an emulsion.

17. The method of claim 16, wherein the chemical dosing step and heating step control the rheology and particle size of the emulsion.

18. A system for the separation of the components of an oil, water, and solids mixture, the system comprising:
a mechanical separation module comprising an oily water output, an oil output, and an input adapted to receive an oil, water, and solids mixture;
a membrane separation module comprising an oily water input, a recirculation output, and a water output;
a chemical dosing module;
a heater module;
wherein the oily water output of the mechanical separation module is in flow communication with the oily water input of the membrane separation module;
wherein the recirculation output of the membrane separation module is in flow communication with the input of the mechanical separation module;
wherein the oil output comprises less than 0.5% BS&W; and
wherein the water output comprises an oil concentration of less than 100 parts per million.

19. A method for separating water and oil from a mixture of water, oil, and particulates, the method comprising the steps of:
flowing a first mixture of oil, water, and particulates into a vessel to reduce the amount of particulates in the first mixture to thereby form a second mixture of primarily oil and water;
flowing the second mixture of oil and water through a separator to reduce the amount of oil in the second mixture thereby forming a third mixture; and
flowing the third mixture into the vessel and the separator to further reduce the amount of oil in the third mixture.

20. The method of claim 19, wherein the third mixture is repeatedly flowed through the vessel and the separator to produce one or more further mixtures, until at least one of the one or more further mixtures comprises a significantly reduced oil concentration.

21. The method of claim 19, wherein the third mixture is repeatedly flowed through the vessel and the separator to produce one or more further mixtures, until at least one of the one or more further mixtures comprises an oil concentration of less than 100 parts per million.

22. The method of claim 19, wherein the third mixture is repeatedly flowed through the vessel and the separator to produce one or more further mixtures, until at least one of the one or more further mixtures comprises an oil concentration of less than 10 parts per million.

23. The method of claim 19, wherein the third mixture is repeatedly flowed through the vessel and the separator to produce one or more further mixtures, until at least one of the one or more further mixtures comprises an oil concentration of less than 5 parts per million.

24. A method for separating water and oil, the method comprising the steps of:
reducing the amount of oil in an oil-water mixture as a first step to produce a first oil-water mixture;
reducing the amount of oil in the first oil-water mixture as a second step to produce a second oil-water mixture;
repeating the first step as to the second oil-water mixture such that one or more further oil-water mixtures is produced, and repeating the second step as to the one or more further oil-water mixtures, until at least one of the one or more further oil-water mixtures comprises a significantly reduced oil concentration.
